(19) United States
(12) Patent Application Publication
(10) Pub. No.: US 2026/0358764 A1
(43) Pub. Date: Nov. 12, 2026

(54) Adaptive Immersive Response System for Readiness-Based Sensory Output Control

(71) Applicant: Amy Jo Lambert, East Peoria, IL (US)

(72) Inventor: Amy Jo Lambert, East Peoria, IL (US)

(21) Appl. No.: 19/672,665

(22) Filed: May 10, 2026

Related U.S. Application Data
(60) Provisional application No. 63/803,781, filed on May 11, 2025.
(60) Provisional application No. 63/803,771, filed on May 11, 2025.
(60) Provisional application No. 63/803,785, filed on May 11, 2025.

(51) Int. Cl. G05B 13/02

(52) U.S. Cl. CPC G05B 13/0205

(57) ABSTRACT

An adaptive immersive response system controls sensory outputs based on user readiness. The system receives user-state information, determines a readiness state and generates sensory output-control parameters. An output control layer generates an output-control data object, and a device registry identifies registered sensory output devices for delivering lighting, audio, projection, augmented reality, mobile, wearable, haptic or environmental outputs. The system may initiate, delay, reduce, suppress, escalate, synchronize or modify sensory outputs based on readiness state, confidence values, movement-state information, biometric information, contextual information, user preferences, device availability or prior response history. A feedback capture module receives post-output user-response information, and the system updates future sensory output-control parameters, readiness thresholds, confidence conditions, suppression conditions, cooldown periods, device priorities or user-specific preference profiles based on the post-output user-response information.

### CROSS-REFERENCE TO RELATED APPLICATIONS

This application is related to U.S. Provisional Patent Application No. 63/803,771, filed May 11, 2025, titled “Poemme: Gracefulness Measurement and Emotionally-Responsive Narrative System,” and U.S. Provisional Patent Application No. 63/803,781, filed May 11, 2025, titled “EverJourney: System AI for Real-Time Adaptive Orchestration of Narrative Wellness Experiences.”

In some embodiments, the systems described in the related applications may provide movement-state data, movement quality data, movement-state trajectories, confidence values, adaptive response-state information, user-state information, contextual information or other control information to one or more embodiments described herein.

The present disclosure is directed to a distinct adaptive immersive response system for readiness-based sensory output control. The embodiments described herein do not require use of the systems described in the related applications unless expressly stated.

### FIELD OF THE INVENTION

The present disclosure relates generally to adaptive sensory output control systems and, more particularly, to systems and methods for determining user readiness and controlling immersive sensory outputs across registered devices based on movement-state information, biometric information, contextual information, confidence values and post-output user-response information.

The disclosed systems may be used in emotional wellness environments, recovery-support environments, aging-in-place environments, creative studio environments, immersive storytelling environments, home environments, entertainment environments, clinical-adjacent environments or other settings in which sensory outputs are adapted based on user readiness.

### BACKGROUND OF THE INVENTION

Immersive environments increasingly use lighting, sound, projection, augmented reality, mobile displays, wearable devices, haptic devices and environmental controls to create sensory experiences. Conventional immersive environments often rely on preset sequences, manual controls, static triggers or predetermined scripts. While such systems may create engaging sensory environments, they generally do not determine whether a user is ready to receive, continue, intensify, reduce, delay or suppress a sensory output based on current user-state information.

Smart home systems may automate lighting, sound, temperature or other environmental devices based on user commands, schedules, location, occupancy, time of day or simple environmental sensor conditions. However, such systems generally do not interpret movement quality, movement-state trajectories, emotional readiness, physical readiness, sensory tolerance or biometric readiness before modifying sensory intensity.

Biofeedback systems may capture physiological signals and present those signals to a user through displays, prompts, audio guidance or breathing exercises. Such systems may guide user behavior or present user-state information, but they generally do not coordinate multiple real-world sensory output devices through a modular device registry that manages device type, capability, availability, latency, priority, user preference and fallback routing.

Augmented reality and virtual reality systems may adapt virtual scenes, virtual objects or virtual content based on user input, gameplay status, biometric state or comfort settings. However, such systems generally operate within a virtual or head-mounted environment and do not provide a separate physical sensory output control layer configured to coordinate lighting, projection, spatial audio, environmental haptics, mobile output, wearable feedback and other real-world sensory devices according to readiness, confidence and post-output response.

Existing systems that adapt sensory output may rely on isolated biometric thresholds, single-device controls or fixed environments. Such systems may not account for movement-state trajectories, confidence values, cumulative sensory load, cooldown conditions, post-output user-response information or user-specific adaptation of future output-control parameters.

Accordingly, a need exists for an adaptive immersive response system that receives user-state information, determines readiness for sensory output, generates output-control data objects, routes outputs through a device registry, coordinates outputs across registered sensory devices, suppresses or reduces outputs when readiness conditions are not satisfied, captures post-output response information and updates future sensory output-control parameters based on user response.

### SUMMARY OF THE INVENTION

In one aspect, a system is provided for adaptive immersive response control. The system may include a signal intake interface, a readiness determination engine, a responsive modulation engine, an output control layer, a device registry, a feedback capture module and a post-output response analysis layer.

The signal intake interface may receive user-state information associated with a user. The user-state information may include movement-state data, movement quality data, movement-state trajectories, biometric data, behavioral data, contextual data, user-entered data, environmental data, historical response data, device availability data, confidence values or combinations thereof.

The readiness determination engine may determine a readiness state based on the user-state information. The readiness state may represent whether a user is suitable for receiving, continuing, intensifying, reducing, delaying or suppressing a sensory output. The readiness state may include or reflect emotional readiness, sensory tolerance, physical readiness, intensity tolerance or combinations thereof.

The responsive modulation engine may determine one or more sensory output-control parameters based on the readiness state, confidence values, user profile information, prior response history, device availability, environmental context, suppression conditions, cooldown conditions or safety conditions.

The output control layer may generate an output-control data object defining how one or more sensory outputs should be selected, timed, routed, synchronized, intensified, reduced, delayed, suppressed, escalated or modified. The output-control data object may include modality, device identifier, timing, intensity, duration, sequence, synchronization timing, content identifier, color, brightness, sound level, spatial audio position, projection state, augmented reality overlay state, haptic pattern, escalation level, suppression condition, cooldown condition or fallback instruction.

The device registry may identify one or more registered sensory output devices available to receive the output-control data object. Registered sensory output devices may include ambient lighting devices, projection devices, audio devices, spatial audio devices, augmented reality devices, mobile devices, wearable devices, haptic devices, environmental haptic devices, temperature control devices, air movement devices or other devices capable of delivering sensory output.

In some embodiments, the system includes an overstimulation prevention layer configured to reduce, suppress, delay, terminate or de-escalate a sensory output when readiness state, confidence value, biometric response, movement-state information, cumulative sensory load, user preference, device condition or another safety condition indicates reduced tolerance for sensory intensity.

The feedback capture module may receive post-output user-response information after delivery of a sensory output. The post-output response analysis layer may compare pre-output user-state information with post-output user-response information and update future sensory output-control parameters, readiness thresholds, confidence conditions, suppression conditions, cooldown periods, device priority values, output modality preferences or user-specific preference profiles.

In some embodiments, the system operates independently. In other embodiments, the system receives movement-state information, movement quality information, confidence values or trajectory information from an upstream movement classification system. In still other embodiments, the system receives adaptive response-state information, output priority information or orchestration instructions from an upstream orchestration system.

In some embodiments, the system receives a narrative scene state, content identifier, transition signal, target sensory intensity value or related cue from an upstream narrative system. The system may permit, delay, reduce, suppress or modify a sensory output associated with the narrative information based on the readiness state.

### BRIEF DESCRIPTION OF THE DRAWINGS

FIG. 1 illustrates an example system architecture for an adaptive immersive response system.

FIG. 2 illustrates example user-state information sources 105 providing input to signal intake interface 110, including wearable sensors 210, non-wearable sensors 220, mobile devices 230, environmental sensors 240, user interfaces 250, upstream movement classification systems 260, upstream orchestration systems 270, narrative systems 280 and stored historical data 290.

FIG. 3 illustrates an example readiness determination engine 130 configured to receive movement-state information 310, biometric information 320, contextual information 330, confidence values 340, user-entered information 350, environmental information 360, prior response history 370 and user-specific baselines 420, and to determine emotional readiness 380, sensory tolerance 390, physical readiness 400 and intensity tolerance 410.

FIG. 4 illustrates an example responsive modulation engine logic flow including readiness state input 462, confidence value input 464, user profile input 466, prior response history input 468, confidence gate 470, suppression decision 472, cooldown decision 474, intensity ramp decision 476, escalation decision 478, output-control parameter set 480 and output-control data object 430.

FIG. 5 illustrates an example output-control data object 430 including output event identifier 432, user identifier 434, timestamp 436, readiness state 438, modality 440, device identifier 442, timing value 444, intensity value 446, duration value 448, sequence value 450, synchronization timestamp 452, content identifier 454, suppression condition 456, cooldown condition 458 and fallback instruction 460.

FIG. 6 illustrates an example device registry architecture including device registry 160, device record 602, device type 604, device identifier 606, communication protocol 608, capability set 610, availability state 612, response latency 614, priority value 616, user preference value 618, fallback device association 620 and registered sensory output devices 170.

FIG. 7 illustrates an example multi-device synchronization process including output-control data object 430, output control layer 150, synchronization layer 702, synchronization timestamp 704, per-device timing offset 706, device command set 708, first sensory output device 710, second sensory output device 712, third sensory output device 714 and output history record 720.

FIG. 8 illustrates an example overstimulation prevention layer 800 configured to receive readiness state input 802, confidence value input 804, biometric response input 806, movement-state input 808 and cumulative sensory load input 810, and to generate suppression condition 812, low-stimulation mode 814, cooldown condition 816, de-escalation instruction 818 or output termination instruction 820.

FIG. 9 illustrates an example post-output response analysis process including pre-output user-state information 902, sensory output delivery 904, post-output response window 906, post-output user-response information 908, post-output response analysis layer 190, response effect classification 910, future parameter update 912, user profile update 914 and output history update 916.

FIG. 10 illustrates an example application programming interface integration layer 1000 connected to upstream movement classification system 1010, upstream orchestration system 1020, optional narrative system 1030, smart home platform 1040, mobile application 1050, wearable device interface 1060, downstream device controller 1070, caregiver-authorized reviewer interface 1080 and post-output response data return path 1090.

### DETAILED DESCRIPTION

### 1. System Overview

The following description sets forth example embodiments of adaptive immersive response systems and methods for readiness-based sensory output control. The described embodiments are illustrative and are not intended to limit the scope of the invention. Features described in connection with one embodiment may be combined with features of other embodiments unless stated otherwise.

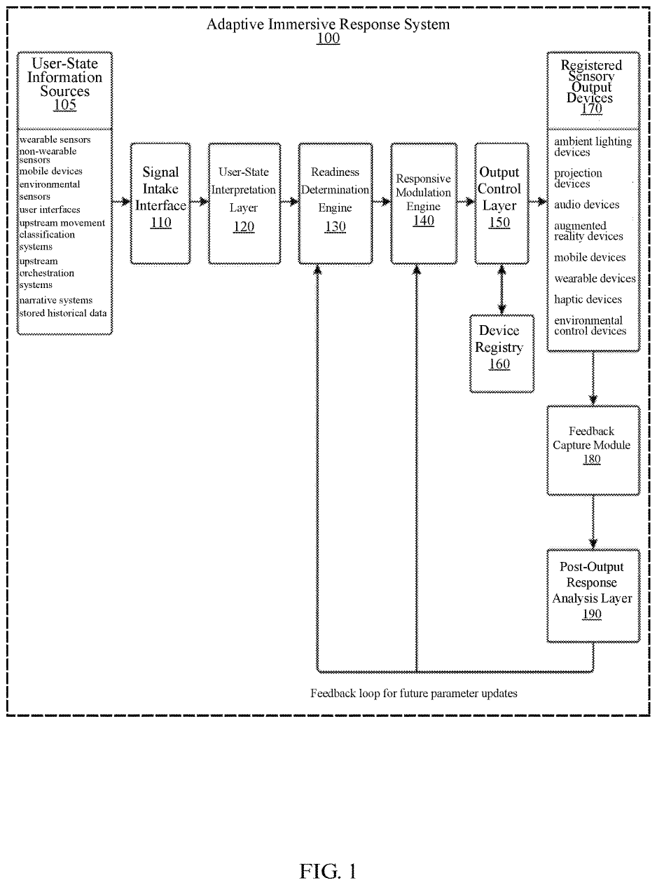

As shown in FIG. 1, an adaptive immersive response system 100 may receive information from user-state information sources 105. The adaptive immersive response system 100 may include a signal intake interface 110, a user-state interpretation layer 120, a readiness determination engine 130, a responsive modulation engine 140, an output control layer 150, a device registry 160, registered sensory output devices 170, a feedback capture module 180 and a post-output response analysis layer 190.

In some embodiments, the system 100 receives user-state information associated with a user. The system 100 determines a readiness state based on the user-state information. The system 100 then determines one or more sensory output-control parameters, generates an output-control data object, selects one or more registered sensory output devices, delivers a sensory output, captures post-output user-response information and updates future sensory output-control parameters based on the post-output user-response information.

The system 100 may be implemented using local processors, wearable processors, mobile processors, edge processors, cloud processors, distributed computing systems, smart home hubs, immersive environment controllers, projection control systems, augmented reality systems, audio systems or combinations thereof.

In some embodiments, the system 100 is configured to operate locally without requiring an external network connection. In other embodiments, the system 100 operates through a hybrid architecture in which latency-sensitive control operations are performed locally while longer-term profile storage, analytics or update functions are performed remotely.

### 2. Definitions

As used herein, “user-state information” may include data associated with a user, including movement-state data, movement quality data, biometric data, behavioral data, contextual data, environmental data, user-entered data, historical response data, device availability data or combinations thereof.

As used herein, “readiness state” may refer to a system-generated representation of whether a user is suitable for receiving, continuing, intensifying, reducing, delaying or suppressing a sensory output.

As used herein, “emotional readiness” may refer to a readiness condition associated with emotional context, user-entered information, biometric steadiness, behavioral response patterns, prior response history or combinations thereof.

As used herein, “sensory tolerance” may refer to a readiness condition associated with a user's ability to receive sensory intensity without triggering suppression, reduction, delay, cooldown or de-escalation logic.

As used herein, “physical readiness” may refer to a readiness condition associated with movement-state information, movement quality, movement stability, movement fluidity, posture, coordination, fatigue indicators or other physical-state signals.

As used herein, “confidence value” may refer to a value, label, range, state or other representation indicating reliability of user-state information, movement-state information, biometric interpretation, sensor quality, classification output or readiness determination.

As used herein, “device registry” may refer to a stored or dynamic record of registered sensory output devices and associated information, including device type, device identifier, modality, communication protocol, capability set, availability state, latency, priority, user preference, suppression rule or fallback association.

As used herein, “output-control data object” may refer to a data object that defines how one or more sensory outputs are to be selected, timed, routed, synchronized, intensified, reduced, delayed, suppressed, escalated or modified.

As used herein, “post-output response window” may refer to a time period after delivery of a sensory output during which user-response information is captured for comparison with pre-output user-state information.

As used herein, “overstimulation prevention layer” may refer to a control layer configured to reduce, suppress, delay, terminate or de-escalate sensory outputs based on readiness state, confidence value, biometric response, movement-state information, cumulative sensory load, user preference or another safety condition.

As used herein, “cooldown condition” may refer to a rule or state that prevents, delays or limits subsequent sensory output, escalation or modality activation for a period or until one or more readiness conditions are satisfied.

As used herein, “Emmersive” may refer to an adaptive immersive response system or environment configured to determine user readiness and control one or more sensory outputs across registered devices based on user-state information, confidence values, readiness conditions and post-output user-response information.

### 3. Signal Intake Interface

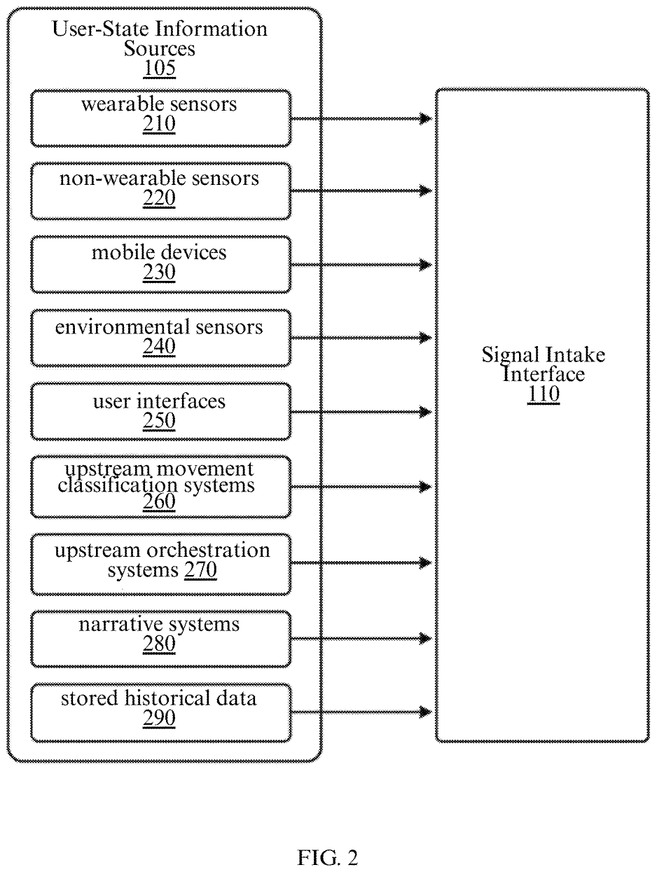

As shown in FIG. 2, the signal intake interface 110 may receive user-state information from one or more sources. Sources may include wearable sensors, non-wearable sensors, mobile devices, environmental sensors, user interfaces, upstream movement classification systems, upstream orchestration systems, narrative systems, smart home platforms, augmented reality systems, virtual reality systems, audio systems or stored historical data.

As shown in FIG. 2, user-state information sources 105 may provide user-state information to signal intake interface 110. User-state information sources 105 may include wearable sensors 210, non-wearable sensors 220, mobile devices 230, environmental sensors 240, user interfaces 250, upstream movement classification systems 260, upstream orchestration systems 270, narrative systems 280, stored historical data 290 or combinations thereof.

Wearable sensors may include inertial measurement units, accelerometers, gyroscopes, magnetometers, heart rate sensors, heart rate variability sensors, respiration sensors, skin conductance sensors, skin temperature sensors, pressure sensors, haptic devices, wearable cameras or combinations thereof.

Non-wearable sensors may include cameras, depth sensors, radar sensors, lidar sensors, pressure mats, floor sensors, environmental sensors, microphones, room occupancy sensors, thermal sensors or other contactless sensing devices.

The signal intake interface 110 may receive movement-state labels, movement-state trajectories, movement quality scores, Flowprint states, Flowpoint states, confidence values or other interpreted movement information from an upstream movement classification system.

The signal intake interface 110 may also receive adaptive response-state information, output priority values, suppression recommendations, escalation recommendations or contextual control information from an upstream orchestration system.

In some embodiments, the signal intake interface 110 receives narrative scene information from an upstream narrative system. Narrative scene information may include a scene label, content identifier, transition signal, target emotional intensity value, target sensory intensity value, timing value, pacing value, scene boundary, character state, setting state, audiovisual content reference or other narrative-associated information.

The signal intake interface 110 may normalize, timestamp, validate, synchronize or package received information before providing the information to the user-state interpretation layer 120 or readiness determination engine 130.

### 4. User-State Interpretation Layer

The user-state interpretation layer 120 may organize user-state information into one or more user-state data objects. A user-state data object may include a user identifier, timestamp, source identifier, movement-state label, movement quality score, trajectory identifier, confidence value, biometric value, environmental value, user-entered context, device state, prior response reference or combinations thereof.

In some embodiments, the user-state interpretation layer 120 combines multiple types of information to characterize a current user state. For example, the system may interpret a user as having reduced readiness when movement-state information indicates instability, biometric information indicates elevated arousal, user-entered context indicates fatigue or prior response history indicates poor tolerance for high-intensity sensory output.

In other embodiments, the system may interpret a user as having increased readiness when movement-state information indicates stable or fluent movement, biometric information indicates steadiness, user-entered context indicates willingness to engage and prior response history indicates favorable response to a similar sensory output sequence.

The user-state interpretation layer 120 may provide interpreted user-state information to the readiness determination engine 130, responsive modulation engine 140, output control layer 150, overstimulation prevention layer or other components of the system 100.

### 5. Readiness Determination Engine

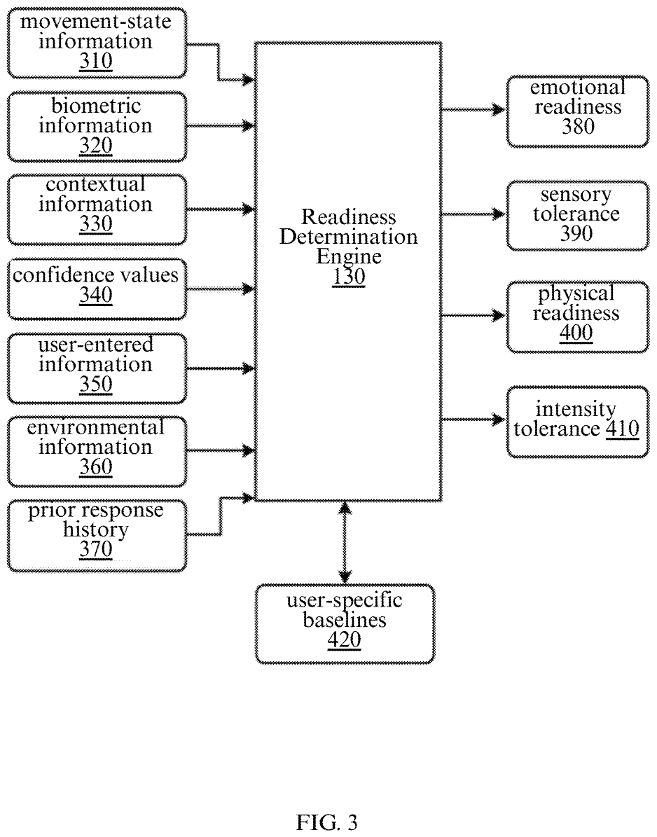

As shown in FIG. 3, the readiness determination engine 130 may determine a readiness state associated with the user. The readiness state may be determined using movement-state information, biometric information, contextual information, confidence values, user-entered information, environmental information, prior response history or combinations thereof.

The readiness state may indicate whether a sensory output should be initiated, continued, intensified, reduced, delayed, suppressed, de-escalated or terminated.

As shown in FIG. 3, readiness determination engine 130 may receive movement-state information 310, biometric information 320, contextual information 330, confidence values 340, user-entered information 350, environmental information 360, prior response history 370 and user-specific baselines 420. Readiness determination engine 130 may determine emotional readiness 380, sensory tolerance 390, physical readiness 400, intensity tolerance 410 or combinations thereof.

In some embodiments, the readiness determination engine 130 determines emotional readiness. Emotional readiness may be based on user-entered emotional context, biometric steadiness, prior response history, engagement duration, attention duration, narrative context, behavioral response or combinations thereof.

In some embodiments, the readiness determination engine 130 determines sensory tolerance. Sensory tolerance may be based on biometric response, user preference, prior response history, cumulative sensory load, environmental intensity, current output exposure, attention duration, engagement duration or combinations thereof.

In some embodiments, the readiness determination engine 130 determines physical readiness. Physical readiness may be based on movement-state labels, movement-state trajectories, movement quality scores, stability information, fluidity information, fatigue indicators, posture information, coordination information, balance information or combinations thereof.

In some embodiments, the readiness determination engine 130 determines intensity tolerance. Intensity tolerance may represent whether the user is suitable for a low, moderate or high-intensity sensory output. Intensity tolerance may also represent whether the system should use a reduced, normal or expanded output-control parameter set.

The readiness determination engine 130 may compare user-state information with user-specific baselines, session-specific baselines, device-specific settings, context-specific rules, prior response history or stored user preferences. The engine may determine that a sensory output should be withheld when user-state information indicates reduced readiness.

The readiness determination engine 130 may also receive or determine a confidence value associated with a readiness state. The confidence value may be based on reliability of sensor data, agreement among signal sources, consistency of movement-state information, quality of biometric data, stability of user-state information, completeness of data or another reliability condition.

### 6. Responsive Modulation Engine

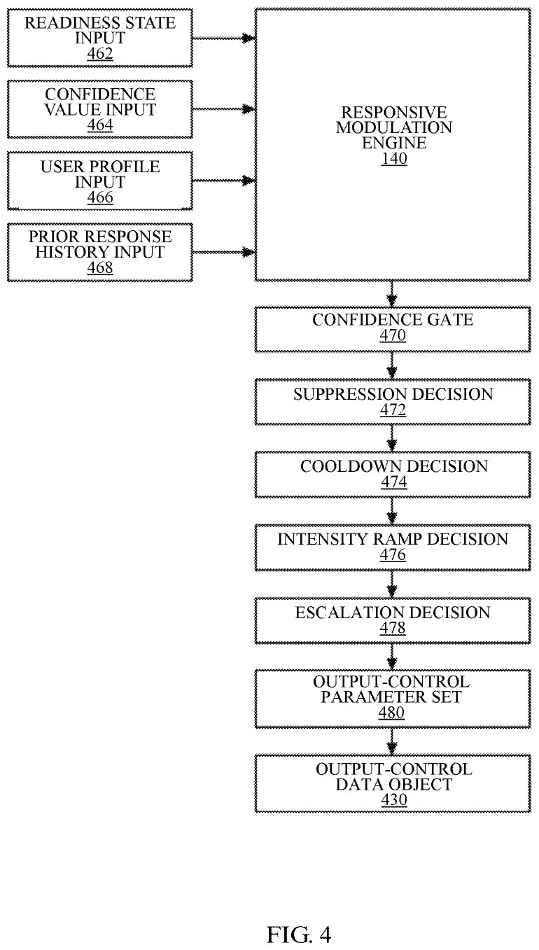

As shown in FIG. 4, the responsive modulation engine 140 may determine how the system should respond to a readiness state. The responsive modulation engine 140 may generate, select or modify one or more sensory output-control parameters based on readiness state, confidence value, user preference, device availability, prior response history, environmental context, suppression conditions, cooldown conditions or other control information.

Sensory output-control parameters may include modality, device identifier, timing, intensity, duration, sequence, synchronization timing, content identifier, color, brightness, sound level, spatial audio position, projection state, augmented reality overlay state, haptic pattern, escalation level, suppression condition, cooldown condition or fallback instruction.

In some embodiments, the responsive modulation engine 140 applies confidence gating. When a confidence value does not satisfy a confidence condition, the responsive modulation engine 140 may suppress a sensory output, delay a sensory output, reduce intensity, select a lower-intrusion modality, route the output to a fallback device or request additional user-state information.

In some embodiments, the responsive modulation engine 140 applies hysteresis to reduce rapid switching between output states. For example, the system may require a readiness state to remain stable before permitting escalation from low-stimulation mode to a higher-intensity output state.

In some embodiments, the responsive modulation engine 140 applies a cooldown condition. The cooldown condition may prevent a subsequent sensory output, prevent escalation, delay activation of a modality or limit output intensity for a period or until one or more readiness conditions are satisfied.

In some embodiments, the responsive modulation engine 140 applies an intensity ramp. An intensity ramp may cause sensory output intensity to increase or decrease gradually rather than changing abruptly. Intensity ramps may be applied to lighting brightness, color transition, audio level, spatial audio movement, projection brightness, haptic intensity, environmental air movement, temperature change or other sensory characteristics.

In some embodiments, the responsive modulation engine 140 selects an output configuration associated with a movement-state label or movement-state trajectory. For example, a stable movement trajectory may permit a richer sensory output, while a transitional or unstable movement trajectory may cause the system to delay, soften or suppress output changes.

As shown in FIG. 4, responsive modulation engine 140 may receive readiness state input 462, confidence value input 464, user profile input 466 and prior response history input 468. Responsive modulation engine 140 may apply confidence gate 470, suppression decision 472, cooldown decision 474, intensity ramp decision 476 and escalation decision 478 to generate output-control parameter set 480. Output-control parameter set 480 may be used to generate output-control data object 430.

### 7. Output-Control Data Object

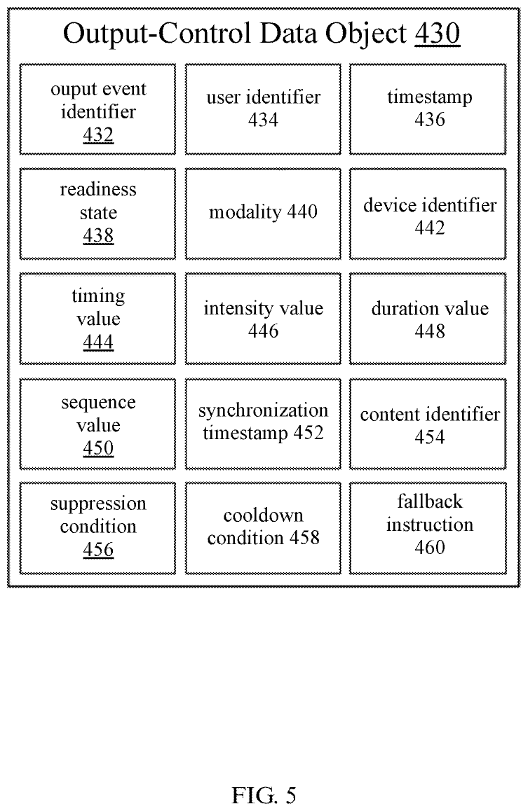

As shown in FIG. 5, the output control layer 150 may generate an output-control data object. The output-control data object may include fields defining how one or more registered sensory output devices should deliver a sensory output.

In some embodiments, an output-control data object includes an output event identifier, user identifier, timestamp, readiness state, selected modality, device identifier, output timing, output intensity, output duration, sequence identifier, synchronization timestamp, content identifier, suppression condition, cooldown condition, escalation level, fallback instruction and output history reference.

As shown in FIG. 5, output-control data object 430 may include output event identifier 432, user identifier 434, timestamp 436, readiness state 438, modality 440, device identifier 442, timing value 444, intensity value 446, duration value 448, sequence value 450, synchronization timestamp 452, content identifier 454, suppression condition 456, cooldown condition 458, fallback instruction 460 or combinations thereof.

For lighting devices, the output-control data object may include color, brightness, color temperature, transition speed, pulse pattern, dimming pattern or sequence state.

For audio devices, the output-control data object may include sound level, soundscape identifier, frequency range, spatial audio position, fade timing, loop condition, suppression condition or transition cue.

For projection devices, the output-control data object may include projection content identifier, brightness, blend state, transition type, timing value, scene state, suppression condition or fallback instruction.

For augmented reality devices, the output-control data object may include overlay state, overlay type, content reference, opacity, position, blend level, transition timing, suppression condition or synchronization timestamp.

For haptic devices, the output-control data object may include pattern identifier, pulse timing, frequency, intensity, duration, rhythm, sequence, escalation level, cooldown condition or suppression condition.

The output-control data object may be transmitted to one device, multiple devices, a device controller, a smart home platform, a projection control system, an augmented reality system, a mobile application, a wearable device or another output controller.

### 8. Device Registry

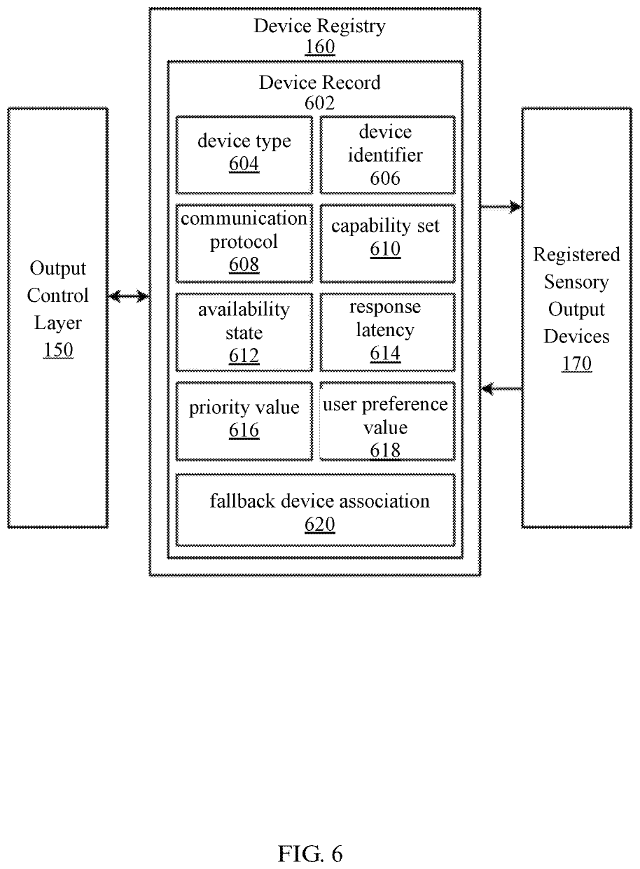

As shown in FIG. 6, device registry 160 may include or access one or more device records 602. A device record 602 may include device type 604, device identifier 606, communication protocol 608, capability set 610, availability state 612, response latency 614, priority value 616, user preference value 618, fallback device association 620 or combinations thereof. Device registry 160 may use device records 602 to identify, select, route commands to or monitor registered sensory output devices 170.

As shown in FIG. 6, the device registry 160 may store records associated with registered sensory output devices. A registered sensory output device may include any device capable of delivering visual, audio, tactile, haptic, environmental, mobile, wearable, projected, augmented or other sensory output.

The device registry 160 may store, for each registered sensory output device, a device type, device identifier, communication protocol, capability set, availability state, response latency, priority value, user preference value, fallback device association, suppression rule, safety limit, location identifier, power status, network status or combinations thereof.

Registered sensory output devices may include ambient lighting devices, projection devices, audio devices, spatial audio devices, augmented reality devices, mobile devices, wearable devices, haptic devices, environmental haptic devices, temperature control devices, air movement devices, display devices, scent devices or other devices.

The device registry 160 may support registration, removal, availability monitoring, capability discovery, priority ranking, fallback routing, location-based routing, user preference matching or protocol-based routing.

In some embodiments, the device registry 160 enables the system 100 to operate across different deployment environments. For example, a home environment may include smart lights, a mobile device and a wearable haptic device. A studio environment may include projection systems, spatial audio, lighting arrays and environmental haptics. A recovery-support environment may include low-intensity lighting, audio and wearable feedback devices.

If a selected device is unavailable, the device registry 160 may identify a fallback device. For example, if a projection device is unavailable, the system may route a visual transition to a lighting device or mobile display. If a spatial audio system is unavailable, the system may route an audio cue to headphones, a speaker or a wearable audio device.

### 9. Output Control Layer

The output control layer 150 may select one or more registered sensory output devices based on the output-control data object and device registry 160. The output control layer 150 may transmit commands to selected devices directly or through device controllers, communication gateways, smart home platforms, media servers, projection systems, audio systems, augmented reality systems or mobile applications.

The output control layer 150 may coordinate delivery of sensory outputs across multiple devices using timing values, sequence values, priority rules, synchronization timestamps, device response latency, fallback routing or combinations thereof.

In one example, the output control layer 150 may cause an ambient lighting device to reduce brightness, cause an audio device to lower sound level, suppress projection output and initiate a low-intensity haptic cue based on a low-readiness state.

In another example, the output control layer 150 may cause a lighting device, spatial audio device and projection device to transition together when a readiness state permits an immersive scene transition.

The output control layer 150 may record output events in output history. Output history may include output event identifier, timestamp, output-control data object, devices used, modalities used, intensity values, duration values, pre-output user-state information, post-output user-response information, response classification and user feedback.

### 10. Multi-Device Synchronization

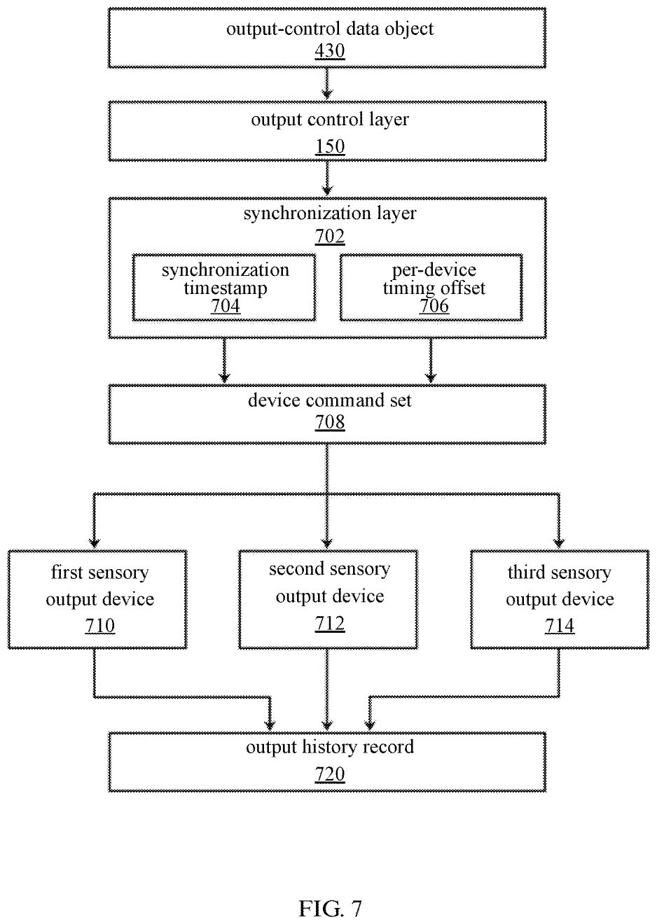

As shown in FIG. 7, the system 100 may include a synchronization layer or synchronization function configured to coordinate sensory outputs across multiple registered devices. The synchronization layer may generate synchronization timestamps, calculate per-device timing offsets, broadcast timing instructions, align output sequences or record timing completion.

As shown in FIG. 7, a multi-device synchronization process may receive output-control data object 430 at output control layer 150. Output control layer 150 may provide information to synchronization layer 702. Synchronization layer 702 may generate synchronization timestamp 704, determine per-device timing offset 706 and generate device command set 708. Device command set 708 may be provided to first sensory output device 710, second sensory output device 712, third sensory output device 714 or additional sensory output devices. Output history record 720 may store information associated with synchronized output delivery.

In some embodiments, different devices may have different response latency values. The device registry 160 may store response latency information for each device. The output control layer 150 may use stored latency information to adjust output timing so that multiple sensory outputs are perceived as coordinated.

For example, a projection device may require a longer preparation interval than a haptic device. The output control layer 150 may send an instruction to the projection device before sending a haptic instruction so that both outputs occur at an intended transition point.

The system may use network synchronization, local clock synchronization, timestamp-based coordination, protocol-specific synchronization or other synchronization techniques. Examples may include local network timing, media server timing, smart home timing, projection timing, audio timing, wearable device timing or augmented reality system timing.

### 11. Overstimulation Prevention Layer

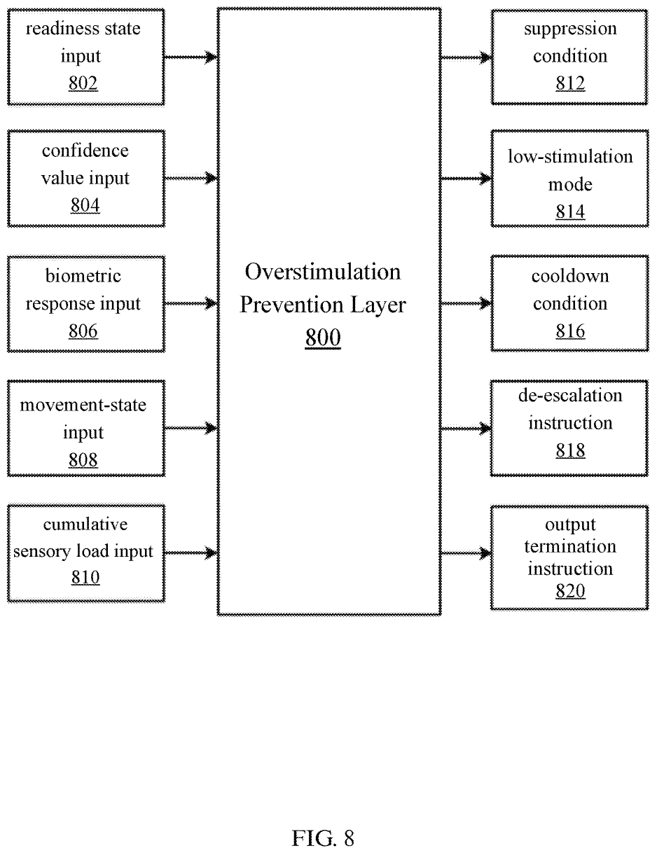

As shown in FIG. 8, the system 100 may include an overstimulation prevention layer. The overstimulation prevention layer may monitor readiness state, confidence value, biometric response, movement-state information, cumulative sensory load, user preference, device state, environmental state or another safety condition.

The overstimulation prevention layer may reduce, suppress, delay, terminate or de-escalate sensory outputs when one or more suppression conditions are satisfied.

Suppression conditions may include readiness below a minimum readiness condition, confidence below a confidence gate, movement-state deterioration, biometric instability, reduced sensory tolerance, user preference, device malfunction, cumulative sensory load, post-output response deterioration, environmental intensity above a stored limit or another condition indicating reduced tolerance for sensory output.

As shown in FIG. 8, overstimulation prevention layer 800 may receive readiness state input 802, confidence value input 804, biometric response input 806, movement-state input 808, cumulative sensory load input 810 or combinations thereof. Overstimulation prevention layer 800 may determine suppression condition 812, initiate low-stimulation mode 814, apply cooldown condition 816, generate de-escalation instruction 818, generate output termination instruction 820 or combinations thereof.

The overstimulation prevention layer may initiate a low-stimulation mode. In low-stimulation mode, the system may reduce lighting intensity, reduce audio level, suppress projection, suppress augmented reality overlays, limit haptic intensity, reduce environmental haptic output, delay scene transitions or prevent escalation to higher-intensity sensory states.

The overstimulation prevention layer may apply per-modality cooldown conditions. A lighting modality, audio modality, projection modality, haptic modality, augmented reality modality or environmental modality may have separate cooldown conditions. The system may also apply a session-level cooldown condition based on cumulative sensory load.

In some embodiments, the overstimulation prevention layer is always active while the system 100 is delivering sensory output. In other embodiments, the overstimulation prevention layer is activated during certain modes, including recovery-support mode, aging-in-place mode, clinical-adjacent mode, low-stimulation mode or user-selected reduced intensity mode.

### 12. Feedback Capture Module

The feedback capture module 180 may receive post-output user-response information after delivery of a sensory output. Post-output user-response information may include biometric data, movement-state data, behavioral response data, attention data, engagement data, user-entered response data, environmental response data or combinations thereof.

Post-output user-response information may be captured during a post-output response window. The post-output response window may begin after a sensory output is initiated, after a sensory output is completed, after a transition point, after a scene change or after another output event.

In some embodiments, the post-output response window is fixed. In other embodiments, the post-output response window is variable, user-specific, modality-specific, context-specific or based on readiness state.

The feedback capture module 180 may capture user-response information from the same data sources used by the signal intake interface 110 or from additional sources. The feedback capture module 180 may store post-output user-response information in output history, user profile data, session history or another storage location.

### 13. Post-Output Response Analysis

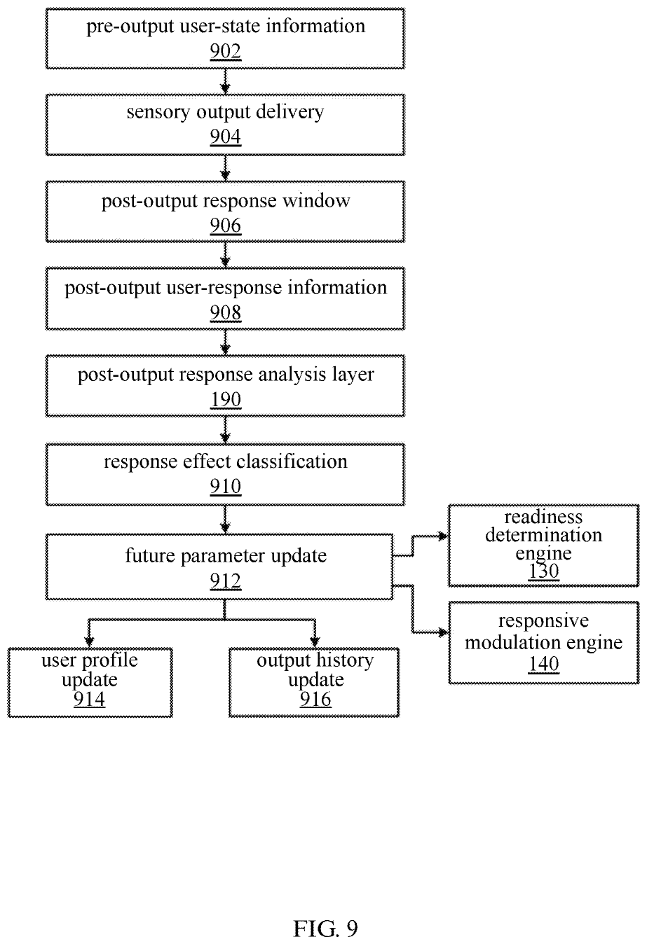

As shown in FIG. 9, the post-output response analysis layer 190 may compare pre-output user-state information with post-output user-response information. The comparison may be used to classify a response effect, update future sensory output-control parameters or modify a user-specific profile.

A response effect may indicate improvement, stabilization, decline, no change, uncertain response, reduced readiness, increased readiness, reduced engagement, increased engagement, increased tolerance, reduced tolerance or another post-output condition.

As shown in FIG. 9, post-output response analysis may include pre-output user-state information 902, sensory output delivery 904, post-output response window 906 and post-output user-response information 908. Post-output response analysis layer 190 may analyze post-output user-response information 908 to generate response effect classification 910 and future parameter update 912. Future parameter update 912 may be used to generate user profile update 914, output history update 916 or updates to readiness determination engine 130 or responsive modulation engine 140.

In some embodiments, if a sensory output is associated with improved or stabilized readiness, the system may increase priority for that output modality, device, intensity level, duration, sequence or timing pattern in future similar contexts.

In some embodiments, if a sensory output is associated with reduced readiness, biometric deterioration, movement-state deterioration, reduced engagement or user-entered discomfort, the system may reduce future output intensity, increase suppression thresholds, lengthen cooldown periods, deprioritize the output modality, select a different device or route future output through a lower-intensity configuration.

The post-output response analysis layer 190 may update readiness thresholds, confidence conditions, device priority values, modality preferences, output intensity ranges, duration values, cooldown conditions, suppression conditions, escalation conditions, user-specific baselines or other output-control parameters.

### 14. User Profile and Adaptation

The system 100 may maintain a user profile. The user profile may include baseline biometric information, baseline movement-state information, preferred output modalities, suppressed output modalities, tolerated intensity ranges, sensory preferences, prior response history, device preferences, accessibility preferences, environmental preferences, cooldown preferences, historical response effectiveness values or combinations thereof.

A user profile may be created during an initial setup process, calibration process, onboarding process, user preference session or early use period. The user profile may be updated over time based on post-output response analysis, user feedback, device availability, context, historical usage or changing user preferences.

In some embodiments, user-specific baselines are used to determine readiness. For example, a biometric value may be interpreted relative to a user's own historical pattern rather than a universal threshold. Similarly, movement-state information may be interpreted relative to the user's own movement history, prior session history, current context or selected mode.

In some embodiments, user profile data is stored locally. In other embodiments, user profile data is stored remotely, stored in encrypted form, synchronized across devices, shared only with user permission or deleted according to user-controlled data settings.

### 15. API Integration Layer

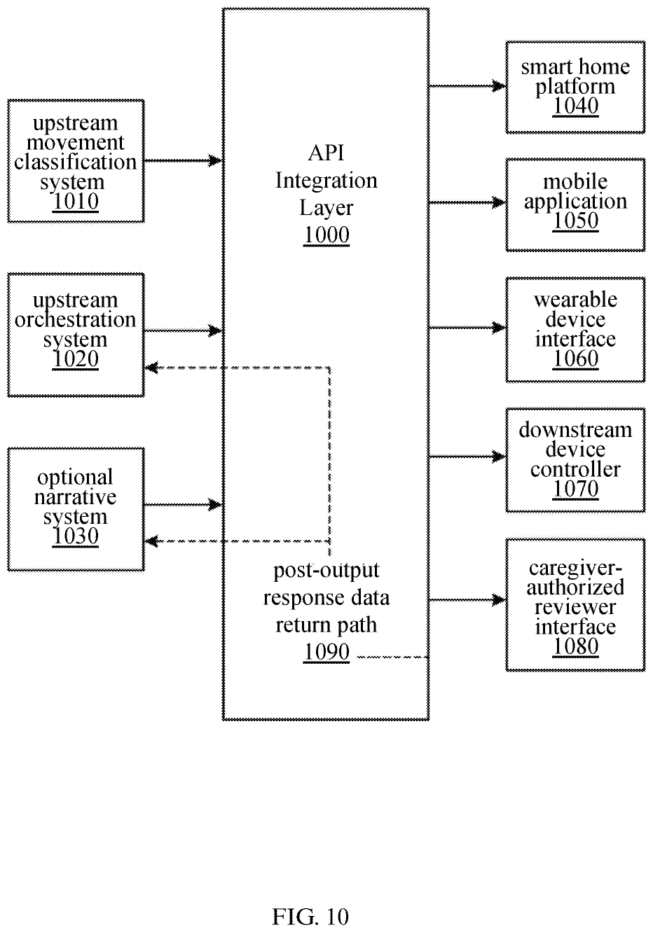

As shown in FIG. 10, the system 100 may include an application programming interface integration layer. The API integration layer may enable communication with upstream systems, downstream devices, third-party platforms, smart home systems, immersive media controllers, mobile applications, wearable devices, narrative systems, caregiver-authorized reviewer interfaces or other systems.

As shown in FIG. 10, application programming interface integration layer 1000 may communicate with upstream movement classification system 1010, upstream orchestration system 1020, optional narrative system 1030, smart home platform 1040, mobile application 1050, wearable device interface 1060, downstream device controller 1070 and caregiver-authorized reviewer interface 1080. Post-output response data return path 1090 may provide post-output response information, response effect information or future parameter update information back through application programming interface integration layer 1000 to one or more upstream systems.

In some embodiments, the API integration layer receives movement-state information from an upstream movement classification system. The movement-state information may include movement-state labels, movement quality scores, movement-state trajectories, confidence values or other interpreted movement information.

In some embodiments, the API integration layer receives adaptive response-state information from an upstream orchestration system. The adaptive response-state information may include output priority, modality recommendation, escalation recommendation, suppression recommendation, timing value, content identifier, reviewer notification state or other response-state information.

In some embodiments, the API integration layer sends post-output response information to an upstream orchestration system. The upstream orchestration system may use the post-output response information to modify future orchestration decisions, response policies, output priorities or user-specific response strategies.

In some embodiments, the API integration layer communicates with downstream device controllers. Downstream device controllers may include lighting controllers, projection controllers, audio controllers, augmented reality controllers, smart home platforms, mobile applications, wearable devices, haptic controllers or environmental control systems.

### 16. Optional Narrative Scene Transition Interface

In some embodiments, the system 100 includes a narrative scene transition interface. The narrative scene transition interface may receive narrative scene state information from an upstream narrative system, storytelling engine, content engine, media controller or other narrative source.

Narrative scene state information may include a scene label, content identifier, target emotional intensity value, target sensory intensity value, transition signal, pacing value, scene boundary, character state, setting state, audio cue, visual cue, projection cue, haptic cue or other information associated with narrative progression.

The system 100 may determine whether the user is ready for a narrative-associated sensory output. If the readiness state satisfies one or more readiness conditions, the system may permit, initiate or coordinate the associated sensory output. If the readiness state does not satisfy one or more readiness conditions, the system may delay, reduce, suppress or modify the associated sensory output.

In some embodiments, the system 100 sends a readiness confirmation, hold signal, reduction instruction, suppression instruction or timing adjustment back to the upstream narrative system. This allows a narrative system to adjust timing or intensity of a scene transition based on user readiness.

The narrative scene transition interface is optional. The system 100 may operate without a narrative system.

### EXAMPLE EMBODIMENTS

### 17. Home Emotional Wellness Environment

In one embodiment, the system 100 operates in a home emotional wellness environment. The signal intake interface 110 receives biometric information from a wearable device, movement-state information from a wearable or non-wearable sensor, user-entered emotional context from a mobile application and device availability information from a smart home platform.

The readiness determination engine 130 determines whether the user is ready for a sensory output. If readiness conditions are satisfied, the responsive modulation engine 140 generates an output-control data object for a lighting device, audio device and wearable haptic device. If readiness conditions are not satisfied, the system enters low-stimulation mode.

The output control layer 150 may cause lighting to warm or dim, audio to reduce or soften and wearable haptic feedback to provide a low-intensity pattern. The feedback capture module 180 captures post-output response information and the post-output response analysis layer 190 updates future output-control parameters.

### 18. Aging-in-Place Support Environment

In one embodiment, the system 100 operates in an aging-in-place environment. The system receives movement-state information from non-wearable sensors, wearable devices or hybrid sensing systems. The system may also receive biometric information, caregiver-authorized context, environmental information and prior response history.

If movement-state information indicates reduced physical readiness or reduced sensory tolerance, the system may generate a de-escalation sequence. The de-escalation sequence may reduce lighting intensity, reduce audio intensity, suppress projection, delay nonessential outputs or initiate a low-intensity environmental comfort sequence.

The system does not determine medical recovery, diagnose a condition or prescribe treatment. The system provides readiness-based sensory output control for emotional wellness, environmental comfort and recovery support.

### 19. Recovery-Support Environment

In one embodiment, the system 100 operates in a recovery-support environment. The system may receive movement-state data, biometric data, user-entered context, environmental context and optional care-team configured preference boundaries.

Care-team configured preference boundaries may be treated as user preferences or environmental constraints rather than clinical prescriptions. The system may use conservative readiness thresholds, lower output intensity limits and stricter cooldown conditions.

The system may provide low-intensity lighting, soft audio, wearable haptic feedback, projection suppression or other reduced sensory output based on readiness state and post-output response.

### 20. Creative Studio Immersive Environment

In one embodiment, the system 100 operates in a creative studio environment. The system receives movement-state information, engagement information, biometric information, user-entered creative context and device availability information.

When readiness conditions indicate that the user is suitable for an immersive creative mode, the system may coordinate lighting, spatial audio, projection and mobile interface outputs. If readiness decreases, the system may reduce sensory intensity, suppress projection or shift to a lower-stimulation configuration.

The system may use post-output user-response information and user-entered feedback to determine which sensory output combinations are associated with favorable creative engagement for the user.

### 21. Narrative Scene Transition Environment

In one embodiment, the system 100 receives a scene transition signal from a narrative system. The scene transition signal may identify a target sensory intensity or scene state.

The readiness determination engine 130 determines whether the user is ready for the proposed scene transition. If readiness conditions are satisfied, the output control layer 150 coordinates lighting, projection, spatial audio, augmented reality overlays or haptic output. If readiness conditions are not satisfied, the system may delay, reduce or suppress the sensory transition.

In some embodiments, the system sends a hold signal, reduced intensity signal or readiness confirmation back to the narrative system.

### 22. Wearable-Only Fallback Embodiment

In one embodiment, the system 100 operates when no environmental sensory output devices are available. The device registry 160 may detect that only one or more wearable devices are registered.

The output control layer 150 may route output-control data objects to wearable haptic devices, wearable displays, wearable audio devices or mobile devices. In this mode, the system continues to determine readiness, apply confidence gates, apply cooldown conditions, capture post-output response information and update future output-control parameters.

### 23. Edge Computing Embodiment

In one embodiment, the system 100 operates using a local edge computing node. The readiness determination engine 130, responsive modulation engine 140, output control layer 150, device registry 160, feedback capture module 180 and post-output response analysis layer 190 may operate locally.

Local operation may reduce latency, support offline use, reduce unnecessary transmission of sensitive user-state information and enable continued operation in environments with limited connectivity.

### 24. Multi-User or Caregiver-Authorized Reviewer Embodiment

In one embodiment, the system 100 includes a caregiver-authorized reviewer interface. A user may authorize a reviewer to view readiness state information, output state information, session summaries or selected user-response information.

The caregiver-authorized reviewer may adjust output limits, pause output, set preference boundaries or initiate a reduced-stimulation mode within permissions established by the user.

In some embodiments, the user retains primary authority over access, permission, output limits and data sharing.

### Privacy, Security and Non-Diagnostic Use

In some embodiments, the system 100 processes user-state information locally when possible. Biometric data, movement-state data, user-entered emotional context, profile information and post-output response information may be stored locally, encrypted, de-identified, permission-controlled or deleted according to user settings.

Communications between system components may use secure transmission. Stored user information may be encrypted. User permissions may control whether information is shared with external systems, caregivers, reviewers, cloud services or third-party platforms.

In some embodiments, the system 100 is configured for emotional wellness, sensory modulation, immersive storytelling, recovery support, aging-in-place support, creative studio experiences, environmental comfort or entertainment contexts.

The system 100 does not itself generate a medical diagnosis, prescribe treatment, determine clinical necessity or determine medical recovery. Physiological, movement-related, behavioral or emotional information may be used for readiness-based sensory output control and user-specific adaptation rather than for diagnosis or treatment.

### Alternative Embodiments

The system 100 may be implemented as a software application, hardware controller, wearable-integrated system, smart home hub, mobile application, cloud service, edge computing system, immersive media controller, projection control system, augmented reality system or distributed system.

The system 100 may operate with one output modality or multiple output modalities. The system may operate with lighting only, audio only, haptics only, mobile output only, wearable output only, projection only, augmented reality only or combinations of modalities.

The system 100 may operate with direct sensor input, interpreted user-state input, upstream system input, user-entered input, environmental input or combinations thereof.

The system 100 may be used in private homes, studios, assisted living environments, wellness environments, recovery-support environments, clinical-adjacent environments, performance environments, entertainment environments, educational environments or other environments where readiness-based sensory output control is useful.

In some embodiments, an adaptive immersive response system as described herein may be referred to as an “Emmersive” system.

What is claimed is:

1. A system for adaptive immersive response control, comprising:
a signal intake interface configured to receive user-state information associated with a user;
a readiness determination engine configured to determine a readiness state based on the user-state information;
a responsive modulation engine configured to determine one or more sensory output-control parameters based on the readiness state;
an output control layer configured to generate an output-control data object based on the one or more sensory output-control parameters;
a device registry configured to identify one or more registered sensory output devices available to receive the output-control data object; and
a feedback capture module configured to receive post-output user-response information after delivery of a sensory output;
wherein the system is configured to update a future sensory output-control parameter based on the post-output user-response information.

2. The system of claim 1, wherein the user-state information comprises one or more of movement-state data, movement quality data, biometric data, behavioral data, contextual data, user-entered data, environmental data, historical response data or device availability data.

3. The system of claim 1, wherein the user-state information comprises a movement-state label, movement-state trajectory or movement quality score received from an upstream movement classification system.

4. The system of claim 1, wherein the user-state information comprises a confidence value associated with movement-state data, biometric data, interpreted user-state data or the readiness state.

5. The system of claim 4, wherein the responsive modulation engine is configured to suppress, delay, reduce or modify the sensory output when the confidence value does not satisfy a confidence condition.

6. The system of claim 1, wherein the readiness determination engine is configured to determine the readiness state based on emotional readiness, sensory tolerance, physical readiness, intensity tolerance or a combination thereof.

7. The system of claim 1, wherein the one or more sensory output-control parameters comprise modality, device identifier, timing, intensity, duration, sequence, synchronization timing, content identifier, color, brightness, sound level, spatial audio position, projection state, augmented reality overlay state, haptic pattern, escalation level, suppression condition or cooldown condition.

8. The system of claim 1, wherein the registered sensory output devices comprise one or more of an ambient lighting device, projection device, audio device, spatial audio device, augmented reality device, mobile device, wearable device, haptic device, environmental haptic device, temperature control device or air movement device.

9. The system of claim 1, wherein the device registry stores, for each registered sensory output device, a device type, device identifier, communication protocol, capability set, availability state, response latency, priority value, user preference value or fallback device association.

10. The system of claim 1, wherein the output control layer is configured to coordinate delivery of sensory outputs across multiple registered sensory output devices using timing, sequence, priority, synchronization or fallback routing.

11. The system of claim 1, further comprising an overstimulation prevention layer configured to reduce, suppress, delay or terminate the sensory output when the readiness state, biometric response, movement-state data, cumulative sensory load, user preference or safety condition indicates reduced tolerance for sensory intensity.

12. The system of claim 11, wherein the overstimulation prevention layer is configured to apply a cooldown condition before permitting a subsequent sensory output, escalation of sensory intensity or transition to a higher-intensity sensory state.

13. The system of claim 1, wherein the feedback capture module is configured to capture post-output biometric data, movement-state data, behavioral response data, attention data, engagement data, user-entered response data or environmental response data during a post-output response window.

14. The system of claim 1, wherein the future sensory output-control parameter is updated by modifying a readiness threshold, confidence condition, device priority, output modality, output intensity, output duration, cooldown condition, suppression condition, escalation condition or user-specific preference profile.

15. A method for adaptive immersive response control, comprising:
receiving user-state information associated with a user;
determining a readiness state based on the user-state information;
generating an output-control data object based on the readiness state;
selecting at least one registered sensory output device from a device registry;
delivering a sensory output through the at least one registered sensory output device;
receiving post-output user-response information after delivery of the sensory output; and
updating a future sensory output-control parameter based on the post-output user-response information.

16. The method of claim 15, wherein determining the readiness state comprises evaluating movement-state data, movement quality data, biometric data, emotional context, sensory tolerance, physical readiness, prior response history or a confidence value.

17. The method of claim 15, further comprising suppressing, delaying, reducing or modifying the sensory output when the readiness state or a confidence value fails to satisfy a threshold condition.

18. The method of claim 15, further comprising coordinating a plurality of sensory outputs across lighting, audio, projection, augmented reality, mobile, wearable or haptic devices according to timing, intensity, sequence or synchronization parameters.

19. The method of claim 15, further comprising receiving a narrative scene state, content identifier, transition signal or intensity value from an upstream narrative system and controlling the sensory output based on both the readiness state and the received narrative information.

20. A non-transitory computer-readable medium storing instructions that, when executed by one or more processors, cause the one or more processors to:
receive user-state information associated with a user;
determine a readiness state based on the user-state information;
generate an output-control data object defining one or more sensory output-control parameters;
select one or more registered sensory output devices from a device registry;
cause delivery of a sensory output through the one or more registered sensory output devices;
receive post-output user-response information; and
update a future sensory output-control parameter based on the post-output user-response information.
